(19) United States
(12) Patent Application Publication
(10) Pub. No.: US 2015/0090649 A1
(43) Pub. Date: Apr. 2, 2015

(54) WATER RECYCLING UNIT

(71) Applicant: INNOVATIVE INDUSTRIES LIMITED, Lancashire (GB)

(72) Inventor: Dean William Crompton, Surrey (GB)

(21) Appl. No.: 14/386,373

(22) PCT Filed: Mar. 19, 2013
(86) PCT No.: PCT/GB2013/050693

§ 371 Date: Sep. 19, 2014

(30) Foreign Application Priority Data
Mar. 21, 2012 (GB) 1204961.5
May 29, 2012 (EP) 12275079.7
Dec. 5, 2012 (GB) 1221918.4

(51) Int. Cl. A47L 11/40; C02F 1/52; C02F 1/461

(52) U.S. Cl. CPC A47L 11/4027; C02F 1/46104; C02F 1/52; A47L 11/4083
USPC 210/192; 210/194; 210/232

(57) ABSTRACT

A water recycling unit for use with a reservoir of water, comprising: a water tank; a water inlet on said tank; and a water outlet on said tank for connection to said reservoir of water, the water inlet being adapted to receive water from the reservoir of water into said water tank, and the water outlet being adapted to supply water to said reservoir, wherein the water outlet is located at a top of said water tank and the water inlet is located below said water outlet, wherein the water tank comprises a settling arrangement and the unit comprises a coagulant delivery means either at or before said water inlet.

### BACKGROUND

1. Technical Field

The present invention relates generally to the field of water recycling units. More particularly, but not exclusively, the present invention concerns a water recycling unit for use with floor cleaning machines.

2. Description of the Related Art

Mobile cleaning machines are used for contract or commercial cleaning of large floor areas, such as walls, ground or floor surfaces.

Mobile floor cleaning machines typically use a lot of water, which is expensive to re-/fill and time inefficient. Recent developments in mobile floor cleaning machines employs a novel on-board water recycling system, which reduces the water used by sucking the water back into the machine, filtering the water and re-using the water.

Unfortunately, not all mobile floor cleaning machines have the capacity to filter water that is sucked back up to a minimum required standard for re-use. Therefore, they need to empty and re-fill the machine. Those machines that do have an on-board filtering apparatus are often expensive and have a much greater footprint as a result, presenting both a storage and a manoeuvrability challenge. Furthermore, with machines having a novel on-board water recycling system, there is still a limit to the number of times that a tank of water can be filtered through the machine before it becomes too dirty to use. A further issue concerns that of the filters, which need to be regularly cleaned or replaced, introducing maintenance as a cost.

Existing technology includes re-fill stations for such machines, where a mobile floor cleaning machine can empty out the used water and re-fill with clean ‘mains’ water. However, such stations can be slow and this, in turn, results in a lot of “downtime” for a mobile floor cleaning machine, which is time inefficient. Furthermore, re-filling a floor cleaning machine with mains water is costly and has a significant environmental impact. With the most efficient cleaning machines, one litre of water can clean an area the size of 60 m²/l. A typical retail store, with an exposed floor area of 7000 m², uses 117 litres of water at 60 m²/l per clean. With a daily clean of the exposed floor space, it is believed that a conservative estimate of annual water usage would therefore be 42,705 litres of water.

With an efficient water recycling floor cleaner, up to 90% of this water can be saved (38000 litres), but this does not present a solution for non-water recycling floor cleaning machines.

Therefore, it is an object of the present invention to address one or more of the problems of the prior art as discussed herein or otherwise.

### SUMMARY OF THE INVENTION

In a first aspect of the present invention there is provided a water recycling unit for use with a reservoir of water, comprising: a water tank; a water inlet on said tank; and a water outlet on said tank for connection to said reservoir of water, the water inlet being adapted to receive water from the reservoir of water into said water tank, and the water outlet being adapted to supply water to said reservoir, wherein the water outlet is located at a top of said water tank and the water inlet is located below said water outlet, wherein the water tank comprises a settling arrangement and the unit comprises a coagulant delivery means either at or before said water inlet.

By ‘coagulant’ what is meant is an agent that neutralizes repulsive electrical charges surrounding particles allowing them to “stick together” creating clumps.

Preferably, the settling arrangement comprises an upper settling chamber and a lower settling chamber. Preferably, the lower chamber substantially comprises a primary settling means. Preferably, therefore, the lower chamber comprises an inverted cone-shape. More preferably, the lower chamber comprises at least a base with an inverted cone-shape. Even more preferably, the lower chamber comprises an inverted pyramidal-shape. Most preferably, the lower chamber comprises a base with an inverted pyramidal-shape.

Preferably, the lower chamber comprises a sediment outlet in the base, more preferably, located substantially centrally in the base and most preferably, at the apex of the inverted cone or pyramid. Preferably, the sediment outlet is connected to a sediment draining or expulsion apparatus that may comprise a manually operable cleaning or flushing nozzle. Preferably, the sediment draining apparatus comprises a removable screen for collecting solids, which can be removed, emptied and replaced. Preferably, the screen is provided between the sediment outlet and the cleaning or flushing nozzle, most preferably just after the sediment outlet. The screen may be any suitable mesh or micron size as appropriate.

Preferably, the water inlet is located proximal to a middle or top portion of the lower chamber. Preferably, the water inlet is adapted to introduce incoming water into the lower chamber tangentially to an inner wall thereof, preferably at a substantially horizontal tangent. Preferably, the water inlet is shaped to maximise water movement in a downward spiral around an inner conical wall of the lower chamber under the action of centrifugal force.

Preferably, the water inlet is adapted to introduce the incoming water into the lower chamber under pressure in order to achieve the downward spiral movement.

The coagulant delivery means may comprise supplying a coagulant dosage at the water inlet. Preferably however, the unit comprises a water extraction apparatus adapted to extract water from said reservoir. Preferably, the water extraction apparatus comprises a water conveying means adapted to convey incoming water to said water inlet. Most preferably, the coagulant delivery means is adapted to supply a coagulant dosage to said incoming water within the water conveying means. Preferably, the water conveying means comprises an extraction pump.

The extraction pump may extract water from a cleaning machine at a rate of at least approximately 50 litres/min, preferably at a rate of at least approximately 70 litres/min, more preferably at a rate of at least approximately 80 litres/min, most preferably, at a rate of up to 150 litres/min.

Preferably, the coagulant delivery means comprises a coagulant reservoir connected to said water conveying means. Preferably, the coagulant dosage is controlled by a dosage pump, preferably a peristaltic pump.

Preferably, the water conveying means is long enough to provide a time delay between dosage of incoming water with the coagulant and the water inlet. Preferably, the water conveying means provides an agitation or mixing means between dosage of incoming water with the coagulant and the water inlet. Therefore, the water conveying means may comprise a spirally-arranged section pipe or tube around the lower chamber, which provides for both accommodation of a longer conveying means and increased agitation of the water/coagulant mix. The spirally-arranged section may begin at a bottom portion of said lower chamber and winds its way up to the water inlet.

Preferably, the water conveying means may comprise a coarse debris trap, which may be located after the extraction pump. The trap may remove debris travelling along the water conveying means and divert it to the sediment draining apparatus via an extra portion of conduit. An electrically actuated ball valve may be located on the extra portion of conduit to control the flow of the diverted debris to the draining apparatus.

Preferably, an end of the water conveying means comprises a detachable adaptor for dropping into the water tank of the cleaning machine for intake of water into the water conveying means. Preferably, the adaptor is removably attached to the water conveying means. Preferably, the adaptor is heavy to facilitate sinking to the bottom of the water tank. Preferably, the adaptor comprises a filtration member through which water intake is effected. Preferably, the adaptor comprises a connector for attachment to the water conveying means. Preferably, the adaptor comprises a base. The base may be between approximately 15 mm and 50 mm deep, preferably, between approximately 20 mm and 45 mm deep. Preferably, the base is flat-bottomed to facilitate an upright stature on a base of the cleaning machine tank, and is preferably hollow. Preferably, the filtration member extends from an upper face of the base. Most preferably, the filtration member comprises a hollow member extending upwardly from the upper face of the base as part of the upper face, such that the hollow of the filtration member and the base are connected. Preferably, the filtration member allows for water intake there through. Preferably, the apertures are between approximately 5 mm and 12 mm wide at the widest part, more preferably, between approximately 6 mm and 10 mm wide at the widest part, most preferably approximately 8 mm wide at the widest part. Preferably, the filtration member comprises a blunted cone-shape. Preferably, the apertures comprise longitudinal holes extending from a base of the cone to a top of the cone. Preferably, the apertures narrow towards the top of the cone. Preferably, the connector comprises a hollow open-ended conduit for connection to the hose. Preferably, the hollow of the connector communicates with the hollow of the filtration member. Preferably, the connector extends from the top of the filtration member. Preferably, the connector, filtration member and the base are integrally formed. Preferably, the adaptor comprises a non-return valve. Preferably, the adaptor comprises a primary filtration means. The primary filtration means may comprise a filter. Additionally, or alternatively, the adaptor may comprise a U-bend therein.

Preferably, the water conveying means comprises a non-return valve close to the adaptor.

The lower chamber may comprise a floating debris removal means. The removal means may comprise a horizontal overflow channel located in a top portion of the lower chamber. Preferably, the overflow channel is located above the water inlet. Preferably, the overflow channel is connected to the cleaning nozzle for expelling any debris.

Alternatively, or additionally, however, the water conveying means may comprise a debris trap, which may be located after the extraction pump. The trap may remove coarse and/or floating debris travelling along the water conveying means and divert it to the sediment draining apparatus via an extra portion of conduit. An electrically actuated ball valve may be located on the extra portion of conduit to control the flow of the diverted debris to the draining apparatus.

Preferably, the lower chamber comprises an air purging means. Preferably, the purging means comprises a horizontal channel located in a top portion of the lower chamber. Preferably, the channel is located above the water inlet. Preferably, the overflow channel is connected to the upper chamber, preferably in a top portion thereof.

Any removal means and the purging or bleeding means may share the same horizontal channel in the top portion of the chamber.

Preferably, the upper chamber is adapted to house cleaned/recycled water that has been displaced from the lower chamber away from the water being treated in the lower chamber.

Preferably, the upper chamber of the water tank comprises an inverted cone-shaped base which extends into the lower chamber providing an opening thereto. The opening is preferably located at, or below the level of the water inlet.

Preferably, the opening and therefore the cone-shaped extension is located substantially centrally in the lower chamber. The cone-shaped base may occupy a top portion of the lower chamber. Preferably, however, the cone-shaped base extends substantially into the lower chamber and preferably, proximal to the base of the lower chamber. Most preferably, inverted cone-shaped base terminates in an opening near to the base of the lower chamber.

The opening may comprise a short downwardly directed tube. Preferably, the cone-shaped base of the upper chamber functions as a secondary settling means.

Preferably, a flow resistance means is provided above the outlet in the base of the lower chamber. Preferably, the flow resistance means comprises a perforated member suspended above the outlet in the base, but below the opening of the cone-shaped bottom of the upper chamber. Preferably the perforated member is hollow and cone-shaped or pyramidal-shaped. Preferably, the perforated member stands on stilts or legs resting or fixed to the base of the lower chamber. Preferably, the perforated member creates resistance against the flow of water into the upper chamber via the opening, which in turn, draws water and sediment under itself towards the outlet of the tank.

Preferably, the perforated member functions as a filtering means.

Preferably, the upper chamber comprises a water supply apparatus. Preferably, the water supply apparatus comprises the water outlet and a water conveying means. Preferably, the supply apparatus comprises a float in the upper chamber connected to the water outlet via a water conduit adapted to float at the water surface. Preferably, the water conduit is at least partially flexible. Preferably, the float and the water conduit are configured to allow for supply of water to the water outlet despite changing water levels in the upper chamber. Preferably, the supply apparatus comprises a supply pump, most preferably provided by the water conveying means.

The supply pump may supply/deliver water to a cleaning machine at a rate of at least approximately 50 litres/min, preferably at a rate of at least approximately 80 litres/min, more preferably at a rate of at least approximately 100 litres/min, even more preferably at a rate of at least approximately 115 litres/min, most preferably at a rate of up to approximately 200 litres/min.

Preferably, waste water (containing dissolved and suspended solids and any floating debris) moves from the reservoir into the extraction apparatus. Preferably, the waste water comprises the coagulant (and any flocculent) as it enters into the lower chamber. Preferably, the solids from the waste water are coagulated and settle out in the bottom of the lower chamber, to be extracted through the sediment outlet and cleaning nozzle. Preferably, any floating debris in the waste water moves into the floating debris removal means, to be extracted through the cleaning nozzle. Preferably, the remaining cleaned or recycled water subsequently moves up into the upper chamber and out through the water supply apparatus. Preferably, any trapped air moves through the unit with the waste water from the extraction apparatus, into the lower chamber, through the air purging channel and into the top portion of the upper chamber.

Preferably, the upper chamber comprises a water treatment component. The water treatment component may comprise an electrically converting water part, using electrodes to split the water into anolytes and catholytes with disinfection and cleaning properties respectively. The treatment component may draw water out of a lower portion of the upper chamber and deposit the anolytes and catholytes back into the upper chamber at a top portion thereof. The treatment component may therefore, comprise a pump. The treatment component may return either one or both of the anolytes or catholytes to the upper chamber for use. Most preferably, the upper chamber comprises a Neutral Electrolysed Water (NEW) unit using Boron doped diamond electrodes to achieve the anolytes and catholytes. The treatment component may be connected to the upper chamber by a port proximal to the inverted cone-shaped base. Preferably, a filtration means is provided before the treatment unit.

Other forms of chemical treatment may be employed by the water treatment unit.

Preferably, the coagulant may also be a flocculent, or is supplemented with a flocculent. By ‘flocculent’ what is meant is an agent that facilitates the agglomeration or aggregation of the coagulated particles to create larger floccules in order to hasten gravitational settling. Alternatively, a separate flocculent delivery means may be provided. The flocculent delivery means may be arranged to introduce a flocculent dosage with or after the coagulant dosage. A flocculent, may, for example, be introduced directly into the lower chamber.

There may be a filtration means provided between the water outlet and the supply nozzle, which may comprise one or more filters. The filtration means is preferably provided before any fast-fill pump.

Preferably, the pumps in the unit are powered through connections to an electricity supply.

Preferably, the unit is operable by a controller. The controller may comprise a series of mechanical switches. Most preferably, the unit is operable via a touch screen controller, preferably a PLC (Programmable Logic Controller). Preferably, the controller provides one or more of the following options: ‘fast fill’ (operable to quickly fill a reservoir of water with recycled water); ‘recycle’ (operable to extract and clean dirty water from a reservoir); and ‘clean me’ (operable to flush the settled sediment and debris from the unit). Preferably, the ‘recycle’ option comprises a mandatory unit cleaning procedure before offering the ‘recycle’ procedure. Preferably, the controller provides the ‘recycle’ option alongside the ‘fast fill’ option.

The ball valve on after the coarse debris trap may be operable automatically during the ‘clean me’ function to allow the debris to be flushed out.

Preferably, the system is adapted to recycle at least 50% of the water intake from said reservoir of water. Preferably, the system is adapted to recycle at least 60% of the water intake from said reservoir, preferably still, at least 70%, more preferably, at least 80%, most preferably, at least 90%.

Preferably, the unit comprises an auxiliary water inlet for introducing ‘fresh’ water into the system. Preferably, the auxiliary water inlet is provided in the upper chamber of the water tank and is connected to a ‘fresh’ water source. Preferably, the auxiliary water inlet comprises a float valve located inside the tank to control opening and closing of the auxiliary inlet. Preferably, the float valve controls a fresh water top-up of the tank through said auxiliary inlet. Preferably, the float valve operates to close the auxiliary inlet to allow the tank to be filled from the cleaning machine, before opening the auxiliary inlet to perform the top-up. Preferably, the float valve closes the auxiliary inlet once the tank reaches an optimal capacity. The auxiliary water inlet may comprise a flow meter. Preferably, the unit comprises a water softening means, preferably located between the auxiliary water inlet and the fresh water source.

Preferably, the unit is adaptable to operate as either a stand-alone unit (being independent of any auxiliary water supply and/or power supply), or as a dependent unit in the sense of either the auxiliary water supply and/or power supply.

Preferably, the unit comprises an option to operate as a dependent unit supported by fixed plumbing. Preferably, therefore, the auxiliary water inlet comprises the option to be permanently connected to a ‘fresh’ water source. Preferably, said permanent connection comprises fixed plumbing to a mains water pipe.

The unit may comprise an option to operate as a ‘stand-alone system’, meaning a system with has no dependencies or requirement for a professional service on installation, such as a wired connection to an electrical junction box electrical connection or fixed plumbing.

The stand-alone system may have an option to be powered by a DC battery on-board a cleaning machine being filled/re-filled. Preferably, the stand-alone system is connected to the DC battery of the cleaning machine by a cooperative electrical connector on the unit. Alternatively, the stand-alone system may be powered by a DC battery on-board the unit itself. In this case, the DC battery may be rechargeable, by either a connection to a recharger or connection to a DC power supply on board the cleaning machine.

Preferably, the unit comprises an option to operate as a dependent unit supported by a fixed power supply. Preferably, therefore, the unit comprises the option to be permanently connected to a mains power supply, for example via an electrical plug.

The reservoir of water may be any suitable containment of water, for example, a water tank from any cleaning machine including a floor cleaning machine, a paddling pool, a small swimming pool, a water storage tank, etc.

Preferably, the unit comprises a frame. The frame may be substantially columnar. The frame is preferably substantially tall and cuboidal. Preferably, the frame comprises removable panels. Preferably, the frame houses substantially all of the components of the unit therein except for those required for day-to-day operation, including the water conveying and water extraction apparatus. Preferably the frame comprises mountings for such external components.

In a second aspect of the present invention there is provided a water re-fill unit for use with cleaning machines, comprising: a water tank; a water inlet on said tank; and a water outlet on said tank for connection to a cleaning machine, wherein the water inlet is adapted to receive water from a cleaning machine and wherein the unit comprises a stand-alone system adapted to recycle at least 50% of the water intake from said cleaning machine using at least one water filtration means.

With this arrangement, at least a proportion of a full tank of dirty water from a cleaning machine can be emptied, recycled and re-piped back into the cleaning machine using an external stand-alone unit, instead of the cleaning machine requiring an on-board filtration system or re-filling the cleaning machine using 100% ‘fresh’ water.

By ‘fresh’ water, what is meant is water from a mains water supply, or collected and filtered rain water.

By ‘stand-alone system’, what is meant is a system has no dependencies or requirement for a professional service on installation, such as a wired connection to an electrical junction box electrical connection or fixed plumbing.

By ‘cleaning machine’ what is meant is any mobile and/or ride-on cleaning machine that uses water to clean and carries said water supply on-board, for example a floor cleaning machine, such as the Surfacemaster® by Innovative Industries Ltd.

Preferably, the system is adapted to recycle at least 60% of the water intake from said cleaning machine, preferably still, at least 70%, more preferably, at least 80%, most preferably, at least 90%.

Preferably, the unit comprises an auxiliary water inlet for introducing ‘fresh’ water into the system. Preferably, the auxiliary water inlet is provided in the water tank. Therefore, the auxiliary water inlet may also be adapted to be temporarily connected to a ‘fresh’ water source. Preferably, said temporary connection requires no professional plumbing installation. Preferably, said temporary connection comprises a hose pipe to a water supply, for example, a tap on a sink, or an outside tap, or a tap on a water butt. Preferably, the unit comprises a water gun to facilitate cleaning of the inside of the water tank. The water gun may use the temporary connection to the auxiliary water inlet. Therefore, the temporary connection to the auxiliary water inlet may detach from the water inlet and attach to a water gun.

The connection between the auxiliary water inlet and/or the water gun may be a non-return valve.

With the above arrangement, the unit can be installed in a location without requiring any plumbing. This makes the unit simple and easy to install and de-limits the number and types of locations that the unit can be placed in. However, also, the unit may be professionally installed if required.

The unit may be adapted to take in up to approximately 50% ‘fresh’ water in a single cycle. Preferably, the unit is adapted to take in up to approximately 40% ‘fresh’ water in a single cycle, more preferably, up to approximately 30%, further preferably, up to approximately 20%, most preferably, up to approximately 10%.

By ‘single cycle’ what is meant is one complete execution of the steps of: water input from a cleaning machine, filtered/re-cycled through the unit and returned to a cleaning machine.

With this arrangement, the unit facilitates a large reduction of the amount of ‘fresh’ or even mains water being drawn for the purpose of floor cleaning. The unit therefore, draws fresh water in order to refresh the filtered/recycled without allowing the water to become too dirty. This provides a good cost saving.

Preferably, the auxiliary water inlet comprises a float valve located inside the tank as described in relation to the first aspect of the invention.

Preferably, the unit comprises a water gun to facilitate cleaning of the inside of the water tank. The water gun may use the temporary connection to the auxiliary water inlet. Therefore, the temporary connection to the auxiliary water inlet may detach from the water inlet and attach to a water gun. The connection between the auxiliary water inlet and/or the water gun may be a non-return valve.

Therefore, preferably, the system is adapted to re-fresh a full tank of water from said cleaning machine in 2-3 cycles using said unit. Preferably still, the system is adapted to re-fresh a full tank of water from said cleaning machine in 4-5 cycles using said unit, more preferably, in 6-7 cycles, even more preferably, in 8-10 cycles, most preferably, in more than 10 cycles.

By ‘refresh’, we mean that the water that is being placed back into the cleaning machine has been completely replaced by ‘fresh’ water over the course of the designated number of recycles of the water through the unit.

With this arrangement, the recycling system keeps water costs to a minimum, whilst ensuring that the water is safe and clean enough for use in a cleaning machine.

Preferably, the stand-alone system comprises a water intake apparatus, a water re-fill apparatus and a water recycle apparatus.

Preferably, the water recycle apparatus comprises said water tank and at least said one filtration means. The water recycle apparatus may further comprise a means for introducing a filtration aid to the water tank. The filtration aid may comprise bio-digesters such as enzymes and bacteria. The filtration aid preferably operates to prevent odour and improve recycled water quality.

The water intake apparatus may comprise the water inlet and a water conductor for location between the inlet and a cleaning machine water outlet. The conductor preferably comprises a hose. The hose may comprise one or a variety of interchangeable adaptors for connection to said cleaning machine water outlet. Preferably, the adaptor comprises a non-return valve.

Most preferably, therefore, the water intake apparatus comprises the water inlet and a water conductor for location between the inlet and a cleaning machine water tank. Again, the conductor preferably comprises a hose. Preferably, the hose comprises an adaptor for dropping into the water tank of the cleaning machine for intake of water into the hose as described in relation to the first aspect of the invention.

Preferably, the water re-fill apparatus comprises the water outlet and a controllable outlet valve.

Preferably, the unit comprises a fast water-recycle mechanism. With this arrangement, time inefficiencies can be minimised by reducing the amount of “downtime” of a mobile floor cleaning machine.

Preferably therefore, the water recycle apparatus is arranged to operate under gravitational force. What is meant by this is that the apparatus involved is arranged to effect natural movement downwards through the apparatus, without requiring any artificial means for moving the water, such as a pump.

Preferably, the unit comprises a fast water re-fill mechanism. With this arrangement, time inefficiencies can be minimised by reducing the amount of “downtime” of a mobile floor cleaning machine.

Preferably therefore, the water re-fill apparatus is arranged to operate under gravitational force.

Preferably, both the water recycle apparatus and the water re-fill apparatus are arranged relative to one another to operate under gravitational force.

More preferably, the stand-alone system has no requirement for an electrical plug connection to a plug point.

Most preferably, the stand-alone system is powered by a DC battery on-board a cleaning machine being filled/re-filled. Preferably, the stand-alone system is connected to the DC battery of the cleaning machine by a cooperative connector on the unit.

Alternatively, the stand-alone system is powered by a DC battery on-board the unit itself. In this case, the DC battery may be rechargeable, by either a connection to a recharger or connection to a DC power supply on board the cleaning machine.

It will be appreciated that references to a cleaning machine may also be interpreted as any other powered device carrying a reservoir of water for cleaning.

With the above power arrangement, the unit can be installed in a location where no power supply is present or convenient and no electrical wiring is required in the install. This makes the unit simple and easy to install, de-limits the numbers and type of locations that the unit can be placed in and removes the requirement for electricity safety testing.

Preferably, the water intake apparatus comprises a water conductor aid. Preferably, the water conductor aid comprises a suction/vacuum device. Preferably, said suction/vacuum device comprises at least one pump. Preferably, the pump comprises a 24 volt diaphragm pump.

Preferably, the pump is operable to connect with and be powered by a DC battery.

Preferably, the pump comprises a connector mechanism. The connector mechanism may comprise a DC connector. Preferably, the DC connector is provided on the end of a lead. Preferably, the lead is long enough to reach to a DC battery of a cleaning machine.

Preferably, the pump is operated by an on/off switch on said pump. Preferably, the pump comprises a timer, so as to automatically switch off after a period of time. The timer may be set to 25 minutes, 20 minutes, 15 minutes, 10 minutes or 5 minutes.

Preferably, the pump is located in operable connection with said conductor close to the water inlet. Preferably, the water inlet is located in a top wall of the water tank of the water recycle apparatus. Preferably, the water intake apparatus feeds water into the water recycle apparatus (tank) under gravitational forces.

Preferably, the first filtration means is located in said tank, but may be disposed externally of said water tank.

The first filtration means may comprise filtration out of particles with a size greater than approximately 1000 μm. Preferably, the first filtration means comprises filtration out of particles with a size greater than approximately 500 μm, more preferably, greater than approximately 250 μm, more preferably, greater than approximately 100 μm.

The first filtration means comprises a filter basket and a filter bag. The filter bag is preferably disposed inside the filter basket.

The water inlet may feed water directly into the first filtration means. The water may therefore, enter the tank through said first filtration means.

Preferably however, the first filtration means is suspended within the water tank. Most preferably, the first filtration means is suspended so as to be disposed below the top wall of the water tank and therefore, below the water inlet. With this arrangement, should the first filtration means become partially/blocked, the water tank will not overflow, as instead, the water will simply flow into the water tank down the sides of the first filtration means.

The filter basket may be suspended via arms extending from inner walls of said tank. Preferably, the filter basket is suspended via one or more horizontal arms extending from inner side walls of the tank. Most preferably, the filter basket is suspended via three horizontal arms extending from inner side walls of the tank.

Preferably, the water recycle apparatus comprises a second filtration means. Preferably, the second filtration means comprises filtration out of particles with a size less than the first filtration means. The second filtration means may comprise filtration out of particles with a size greater than approximately 500 μm. Preferably, the second filtration means comprises filtration out of particles with a size greater than approximately 250 μm, more preferably, greater than approximately 100 μm, more preferably, greater than approximately 50 μm, most preferably greater than approximately 25 μm.

Preferably, the second filtration means is located below the first filtration means. Preferably, the second filtration means is located outside the water tank. Prefer ably the second filtration means is located below the tank. Preferably, the second filtration means is located on an outlet pipe from said tank.

Preferably, the water re-fill apparatus comprises an outlet pipe. Preferably, the second filtration means is located above said outlet valve on said outlet pipe. Preferably, said outlet valve is a manual ball valve.

Preferably, the water outlet of the water re-fill apparatus is adapted to connect to a hose for attachment to a water inlet of a cleaning machine.

Preferably, the unit comprises a frame. Preferably, the frame is adapted for attachment to a wall, support structure or floor. The frame may alternatively be provided with wheels thereon, such as castors, for mobility.

The frame preferably comprises mountings for the water tank, the water re-fill apparatus and the water intake apparatus. Preferably the frame comprises a water tank elevation shelf. Preferably, the frame comprises a housing for the water conductor of the intake apparatus. Preferably, the frame comprises a supporting bracket for the water re-fill apparatus.

The unit may filter water from a cleaning machine at a rate of up to approximately 10 litres/min. Preferably, the unit filters water from a cleaning machine at a rate of up to approximately 20 litres/min, more preferably, at a greater rate than 20 litres/min. This will depend upon the capacity of the pump installed.

The unit may empty a cleaning machine of dirty water at a rate of up to approximately 10 litres/min. Preferably, the unit empties a cleaning machine of dirty water at a rate of up to approximately 20 litres/min, more preferably, at a greater rate than 20 litres/min. Again, this will depend upon the capacity of the pump installed.

Preferably, the unit re-fills a cleaning machine at a rate of up to approximately 500 litres/min, more preferably, at a rate of up to approximately 3000 litres/min (for example, a 500 litre tank in 10 seconds).

The tank may have a capacity of between approximately 15 litres and approximately 500 litres. Preferably, the unit is available in the following capacities: 15 litres, 50 litres, 100 litres, 250 litres and 500 litres.

Preferably, at least a bottom portion of the frame is closed with panels. The panels may be removably attached to allow access therein. The frame may comprise attachments or housings for holding other cleaning utensils thereon.

In a third aspect of the invention there is provided an adaptor for connection to a water conductor, the adaptor being suitable for location in a water reservoir to facilitate water intake therefrom, wherein the adaptor comprises a mass great enough to facilitate sinking to a bed of the water reservoir and comprises a filtration member through which water intake is effected and a connector for attachment to the water conductor.

Preferably, the adaptor is removably attachable to the water conductor. The conductor may comprise a hose. Preferably, the adaptor comprises a non-return valve.

Preferably, the adaptor comprises a base. Preferably, the base is flat-bottomed and is preferably hollow. The base may be between approximately 15 mm and 50 mm in depth, preferably, between approximately 20 mm and 45 mm in depth.

Preferably, the filtration member extends from an upper face of the base. Most preferably, the filtration member comprises a hollow member extending upwardly from the upper face of the base as part of the upper face, such that the hollow of the filtration member and the base are connected. Preferably, the filtration member allows for water intake there through. Preferably, the filtration member comprises apertures between approximately 5 mm and 12 mm wide at the widest part, more preferably, between approximately 6 mm and 10 mm wide at the widest part, most preferably approximately 8 mm wide at the widest part. Preferably, the filtration member comprises a blunted cone-shape. Preferably, the apertures comprise longitudinal holes extending from a base of the cone to a top of the cone. Preferably, the apertures narrow towards the top of the cone.

Preferably, the connector comprises a hollow open-ended conduit for connection to the water conductor. Preferably, the hollow of the connector communicates with the hollow of the filtration member. Preferably, the connector extends from the top of the filtration member.

Preferably, the connector, filtration member and the base are integrally formed.

It is to be appreciated that the adaptor of the third aspect may be used with the unit of the first and second aspects, but may also be used with other apparatus where a water conductor is being used to empty a water reservoir.

### BRIEF DESCRIPTION OF THE DRAWINGS

For a better understanding of the invention, and to show how exemplary embodiments may be carried into effect, reference will now be made to the accompanying drawings in which:

FIG. 1 is a semi-schematic diagram of a water recycling unit according to one embodiment of the invention;

FIG. 2 is a semi-schematic diagram of a water recycling unit according to an exemplary embodiment of the invention;

FIG. 3a is a plan view of a cap as used in FIG. 2;

FIG. 3b is a perspective view of the cap of FIG. 3a;

FIG. 4 is a perspective view of an exemplary embodiment of an adaptor for use with the water re-fill unit of FIG. 1; and

FIG. 5 is a perspective view of a water recycling unit according to another embodiment of a water recycling unit according to the invention.

### DETAILED DESCRIPTION OF THE EXEMPLARY EMBODIMENTS

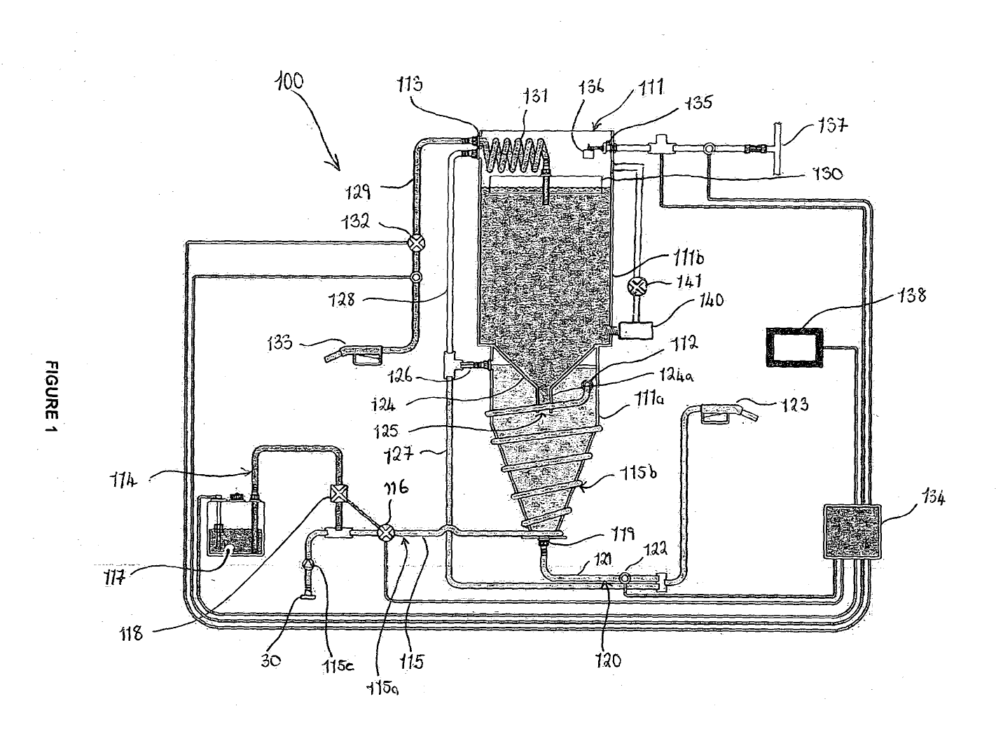

FIG. 1 is a water recycling unit (100) for use with a reservoir of water, comprising: a water tank (111); a water inlet (112) on said tank (111); and a water outlet (113) on said tank (111) for connection to said reservoir of water, the water inlet (112) being adapted to receive water from the reservoir of water into said water tank (111), and the water outlet (113) being adapted to supply water to said reservoir, wherein the water outlet (113) is located at a top of said water tank (111) and the water inlet (112) is located below said water outlet (113), the water tank (111) comprising a settling arrangement (111a, 111b) and the unit (100) comprises a coagulant delivery means (114) either at or before said water inlet (112).

For the purpose of describing the invention in detail, the unit (100) will be described by reference to use with a cleaning machine, although it will be appreciated that the invention could be used with other powered devices, or unpowered apparatus with a reservoir of water, for example, a water tank from any cleaning machine including a floor cleaning machine, a paddling pool, a small swimming pool, a water storage tank, etc.

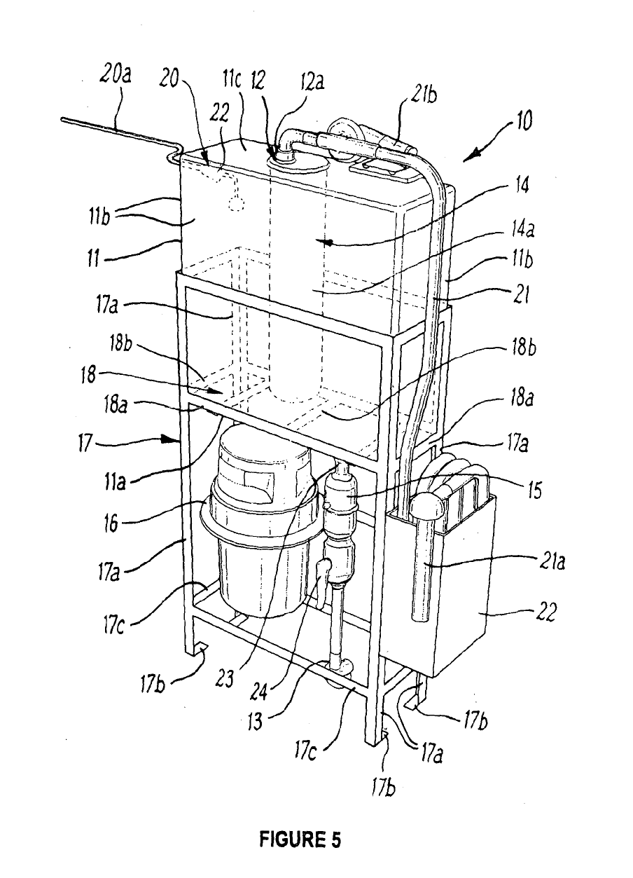

The unit comprises a water extraction apparatus that is adapted to extract water from said reservoir comprising a water conveying hose (115) that is dropped into a water tank of a cleaning machine (not shown). The end of the hose (115) comprises an adaptor (30). The adaptor (30) is described more fully below in relation to FIG. 5, but functions as an initial crude filtration means. The hose (115) comprises a non-return valve (115c) adjacent the end thereof. The hose (115) further comprises an extraction pump (116) to aid dirty water extraction from the cleaning machine reservoir into the unit (100). The extraction pump (116) extracts water from a cleaning machine at a rate of approximately 80 litres/min.

The coagulant delivery means (114) is adapted to supply a coagulant dosage to said incoming dirty water. The coagulant operates to neutralize the repulsive electrical charges surrounding particles allowing them to clump together. The coagulant delivery means (114) comprises a coagulant reservoir (117) connected to said hose (115). Between the hose (115) and the reservoir (117) there is provided a dosage pump, preferably a peristaltic pump (118) in order to control the coagulant dosage.

The hose (115) is made long enough to provide a time delay between dosage of incoming water with a coagulant and the water inlet and in this case is also configured to provide an agitation means between the dosage of incoming water with the coagulant and the water inlet (112). Therefore, the hose (115) comprises a handling section (115a) for manoeuvring by an operator to a water cleaning machine and a spirally-arranged section (115b) arranged around a portion of the water tank (111) before entering the water tank (111) at the water inlet (112).

The settling arrangement comprises a lower settling chamber (111a) and an upper settling chamber (111b) as part of the water tank (111).

The upper chamber (111b) is substantially cube-shaped with an inverted cone-shaped bottom (124). The bottom (124) sits substantially centrally within a top portion of the lower chamber (111a) and is in fluid communication therewith via an opening (125) in the bottom (124) provided by a short tube (124a) extending downwardly from the bottom (124).

The lower chamber (111a) comprises an inverted substantially cone-shaped compartment disposed centrally below the upper chamber (111b). The lower chamber (111a) comprises a sediment outlet (119) at a base thereof, e.g. at the apex of the cone. The sediment outlet (119) is connected to a sediment draining apparatus (120) comprising a removable screen or trap (not shown) just below the outlet (119), a conduit (121) with a pressure sensor (122) disposed thereon and a manually operable cleaning nozzle (123) at the end thereof.

The water inlet (112) is located proximal to a top portion of the lower chamber (111a) and is adapted to introduce incoming water into the lower chamber (111a) tangentially to an inner wall thereof. The water inlet (112) is shaped to maximise water movement in a downward spiral around an inner conical wall of the lower chamber (111a) to encourage settling of the sediment toward the sediment outlet (119) and cause a central and upward displacement of the water already within the lower chamber (111a). The opening (125) in the upper chamber (111b) bottom (124) is located below the level of the water inlet (112).

The spirally-arranged section (115b) of the hose (115) is wound around the lower chamber (111a) from the bottom of the lower chamber (111a) proximal to the sediment outlet (119) upwardly to the water inlet (112). This provides for both accommodation of a longer hose (115) for coagulation to take place and increases the amount of agitation that the water/coagulant mix is subjected to for the coagulant to take effect.

The lower chamber (111a) comprises a floating debris removal means in the form of a horizontal overflow channel (126) located in the top portion of the lower chamber (111a), but above the level of the water inlet (112). The overflow channel (126) is connected to the cleaning nozzle (123) for expelling any debris via a debris conduit (127). However, the overflow channel (126) also communicates with an air bleed hose (128) that exits within a top portion of the upper chamber (111b) in order that air being pushed out of the lower chamber (111a) by incoming water can be displaced to the upper chamber (111b).

The upper chamber (111b) comprises a water supply apparatus to re-fill a cleaning machine comprising the water outlet (113) and hose (129) proximal to a top of the tank (111). Since the water outlet (113) is fixed at an upper level in the upper chamber (111b) in order to supply the cleanest water from the tank (111), the water needs to be delivered to the outlet (113) as required. Accordingly, the supply apparatus comprises a float (130) connected to the outlet (129) via a flexible conduit (131). Furthermore, the hose (129) comprises a supply pump (132) to draw water through the conduit (131) and the hose (129) at a rate of approximately 115 litres/min to a manually operated supply nozzle (133).

In an exemplary embodiment of the invention, the coagulant is also, or also contains a flocculent (to facilitate the agglomeration or aggregation of the coagulated particles to create larger floccules in order to hasten gravitational settling).

The upper chamber (111b) comprises a water treatment unit (140) operable to electrically convert water using electrodes to split the water into anolytes and catholytes with disinfection and cleaning properties respectively. In a most exemplary embodiment, the upper chamber (111b) comprises a Neutral Electrolysed Water (NEW) unit using Boron doped diamond electrodes to achieve the anolytes and catholytes. The treatment unit (140) is connected to the upper chamber (111b) at a low level where it draws water out of the chamber (111b) aided by a pump (141) and deposits the anolytes and catholytes back into the chamber (111b) at a top portion thereof.

The pumps (116, 118, 132, 141) are powered through wired connections to an electric power supply (134). The unit (100) has the capability to draw power from either the mains electricity supply (134) via a plug, or from a DC battery of a cleaning machine via an appropriate DC connector (not shown). Accordingly, the unit (100) is configured to operate as either a dependent unit supported by mains power or an independent mobile unit supported by a temporary connection to a mobile battery.

The unit (100) comprises an auxiliary water inlet (135) for introducing ‘fresh’ water into the system from time to time. The auxiliary water inlet (135) is provided in the upper chamber (111b) of the water tank (111) above the water line and comprises a float valve (136) located inside the tank to control opening and closing of the auxiliary inlet (135), when the water level is low in the water tank (111).

The auxiliary inlet (135) may be permanently connected to a mains water supply (137) or temporarily connected to a sink tap (not shown) via a removable hose (not shown). Accordingly, the unit (100) is configured to operate as either a dependent unit supported by fixed plumbing or an independent mobile unit supported by a temporary connection to a nearly tap.

The unit (100) is operable via a touch screen controller (138). The controller (138) provides a predetermined sequence of instructions and functions in order to ensure that the unit (100) is operating correctly and most efficiently. Therefore, the controller (138) provides for a ‘fast-fill’ function using the water supply apparatus and a ‘recycle’ function using the water extraction apparatus.

The ‘fast-fill’ function initiates the water supply apparatus and activates the supply pump (132) upon operation of the supply nozzle (133). Accordingly, upon selection of the ‘fast fill’ function, the operator is instructed to take the supply nozzle (133), insert it into an opening in the water tank of the cleaning machine and depress the trigger until the machine tank is full. The controller (138) initiates the supply pump (132), which draws water from the upper chamber (111b) through the conduit (131) out through the water outlet (113) into the hose (129) to the nozzle (133). As the water level in the upper chamber (111b) decreases, the float (130) drops with the level of the water in order that the conduit (131) is able to continue to draw water from the chamber (111b).

The ‘recycle’ function is provided as an option alongside the ‘fast fill’ function, but is interrupted by a mandatory unit cleaning procedure before reverting to the ‘recycle’ function using the water extraction apparatus. Therefore, upon selection of the ‘recycle’ function by an operator, the controller (138) presents a ‘clean me’ function along with an instruction to operate the cleaning nozzle (123) until the water runs clear. Upon operation of the cleaning nozzle (123), the sediment from the lower chamber (111a) is drawn through the sediment outlet (119) and the conduit (121) at the same time as debris is drawn through the debris conduit (127) and out through the cleaning nozzle (123). This function removes a significant amount of the sediment from the water tank (111) before introduction of more dirty water.

Once the ‘clean me’ function is complete, the controller (138) reverts to the ‘recycle’ function, upon selection of which, the operator is instructed to insert the hose (115) with adaptor thereon (30) into the tank of the cleaning machine. The controller (138) initiates both the dosage pump (118) and the extraction pump (116) which operate together to draw water into the hose whilst providing a dosage of coagulant to the dirty incoming water from the coagulant reservoir (117). The water/coagulant mix travels through the handling section (115a) of the hose (115) to the spirally arranged section (115b), where the water coagulant mix is agitated until the water is exited through the water inlet (112) into the lower chamber (111a). By this time, the coagulant has caused coagulation of a significant proportion of the sediment in the dirty water. The water/coagulated sediment is exited at a horizontal tangent to the inside wall of the lower chamber (111a) such that it takes a close spiral path around the inside of the lower chamber (111a) from top to bottom encouraging settling out of the coagulated sediment at the bottom of the chamber (111a), whilst at the same time displacing clean water already in the lower chamber (111a) centrally and upwardly through the opening (125) into the upper chamber (111b) (ready for the next ‘fast fill’ function). In the event that the water level in the upper chamber (111b) is detected by the float valve (136) to be too low, the controller (138) present s the option to ‘top-up’ the tank (111) through the auxiliary water inlet (135), whether connected via a plumbed connection, or a temporary connection to a fresh water supply. Upon selection of the ‘top-up’ function, the operator is prompted to check for a connection to an auxiliary water supply and then the apparatus can draw water into the tank (111) until the float valve (136) shuts off the inlet (135).

Once the ‘recycle’ function is complete, the ‘fast-fill’ function is presented to the operator as before.

Therefore, in use, dirty water moves through the unit (100) from the extraction apparatus (30, 114, 115, 116, 117, 118), into the lower chamber (111a), up into the upper chamber (111b) and out through the water supply apparatus (113, 129, 132, 133). Sediment moves through the unit (100) from the extraction apparatus (30, 114, 115, 116, 117, 118), into the lower chamber (111a), and settles out in the bottom of the lower chamber (111a), to be extracted through the sediment outlet (119) and cleaning nozzle (123). Floating debris moves through the unit (100) from the extraction apparatus (30, 114, 115, 116, 117, 118), into the lower chamber (111a), through the floating debris removal means (126), to be extracted through the cleaning nozzle (123). Trapped air moves through the unit (100) from the extraction apparatus (30, 114, 115, 116, 117, 118), into the lower chamber (111a), through the channel (126) and into the top portion of the upper chamber (111b).

The unit (100) is adapted to recycle at least 50% of the water intake from a reservoir of water, but testing has shown that it capable of recycling up to around 90% of the water intake from a cleaning machine.

With this arrangement, the unit is easy-to-operate and maintain, whilst effectively cleaning water: no filters are used and so, maintenance costs and time can be kept to a minimum. Furthermore, an operator can refill the coagulant reservoir with ease, again minimising maintenance costs and time. The unit (100) can be mobile or fixed in position as required.

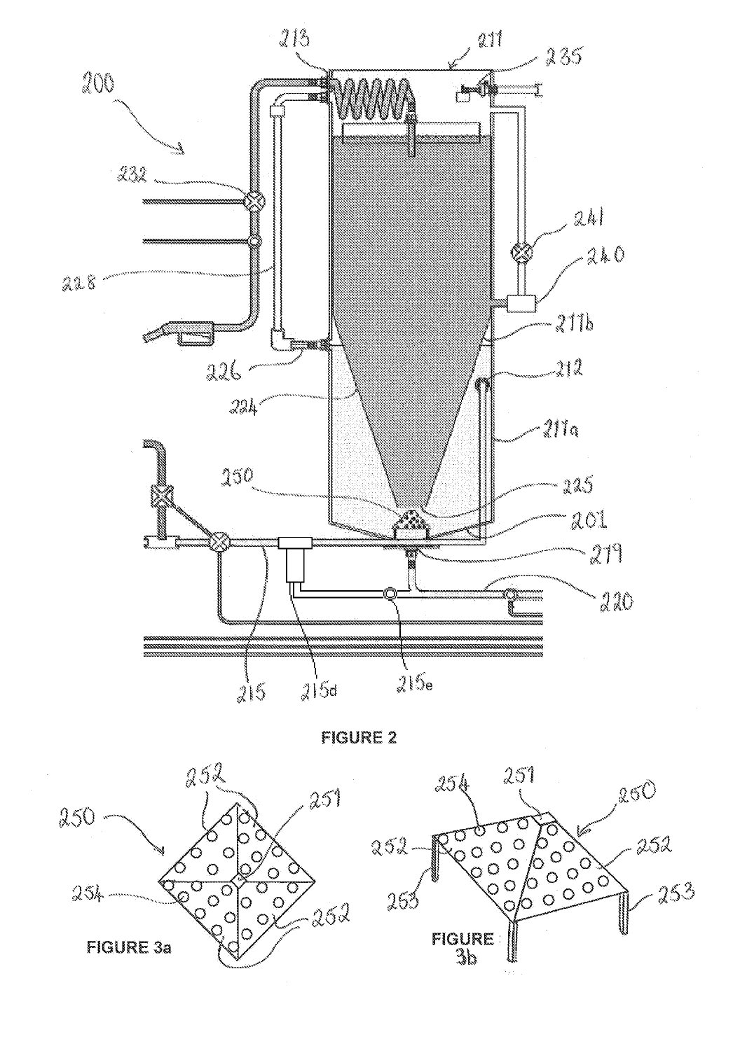

FIG. 2 is an exemplary arrangement for a water recycling unit (200) for use with a reservoir of water. Only a part of the schematic arrangement is shown since the rest of the unit (200) is the same as that shown in and described in relation to FIG. 1.

The unit (200) comprises: a water tank (211); a water inlet (212) on said tank (211); and a water outlet (213) on said tank (211) for connection to said reservoir of water, the water inlet (212) being adapted to receive water from the reservoir of water into said water tank (211), and the water outlet (213) being adapted to supply water to said reservoir, wherein the water outlet (213) is located at a top of said water tank (211) and the water inlet (212) is located below said water outlet (213), the water tank (211) comprising a settling arrangement (211a, 211b) and wherein the unit (200) comprises a coagulant delivery means (not shown) either at or before said water inlet (212).

The unit (200) further comprises a water extraction apparatus (215) that is adapted to extract water from said reservoir comprising a water conveying hose (215a) as shown in and described in relation to FIG. 1. The water extraction apparatus (215) comprises a coarse debris trap (215d) on the hose (215a) after an extraction pump (216). The trap (215d) traps debris travelling along the hose (215a) and diverts it to the sediment draining apparatus (220) via an extra portion of conduit. An electrically actuated ball valve (215e) located on the extra portion of conduit controls the flow of the diverted debris to the draining apparatus (220). The ball valve (215e) is operable automatically during the ‘clean me’ function to allow the debris to be flushed out.

The settling arrangement comprises a lower settling chamber (211a) and an upper settling chamber (211b) as part of the water tank (211).

The upper chamber (211b) is substantially rectangular-shaped with an inverted cone-shaped extension (224). The bottom (224) extends substantially centrally downwardly into lower chamber (211a) and is in fluid communication therewith via an opening (225) at the end of the extension (224). The opening (225) in the upper chamber (211b) extension (224) is located well below the level of the water inlet (212) and is in fact located proximal to a base (201) of the lower chamber (211a).

The lower chamber (211a) comprises a substantially rectangular shape with a shallow inverted pyramidal-shaped base (201) disposed centrally below the opening (225) in the extension (224). The lower chamber (211a) comprises a sediment outlet (219) at a base thereof, e.g. at the apex of the base (201). The sediment outlet (219) is connected to a sediment draining apparatus (220) as shown in and described in relation to FIG. 1. The extension (224) extends downwardly to almost the level at which the walls of the chamber (211a) terminate to provide the pyramidal-shaped base (201).

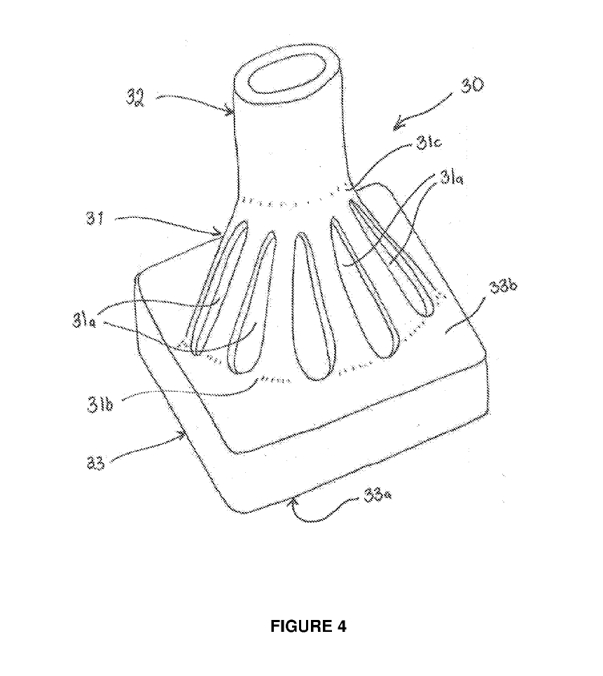

Within the lower chamber (211a) between the outlet (219) of the base (201) and the opening (225) of the cone (224), is provided a hollow pyramidal cap (250) comprising a flat top (251) and four substantially triangular walls (252) extending therefrom. The walls (252) are perforated with apertures (254). The cap (250) is shown in more detail in FIGS. 3a and 3b. The cap (250) is raised from the base (201) of the chamber (211a) by short legs or stilts (253) and is positioned centrally in relation to the outlet (219) and the opening (225). The cap (250) is positioned such that water can enter the opening (225) by either, passing between the cap (250) and the walls of the extension (224), or by travelling through the cap (250) from below.

The arrangement of the cap (250), opening (225) and outlet (219) performs a number of useful functions:
(1) The sloped pyramidal base (201) facilitates the channelling of sediment down to the outlet (219) for extraction/removal from the tank (211) during the ‘clean me’ function;
(2) The cap (250) creates a filter/strainer for water moving up into the upper chamber (211b) from below the cap (250), where sediment has settled; and
(3) The cap (250) increases the water resistance of the flow of water from below the cap (250) moving up into the upper chamber (211b), which in turn causes sediment and water to be drawn down to the base (201) of the tank (211) below the cap for expulsion.

The water inlet (212) is located proximal to a top portion of the lower chamber (211a) and is adapted to introduce incoming water into the lower chamber (211a) tangentially to an inner wall thereof. The water inlet (212) is shaped to maximise water movement in a downward spiral around an inner wall of the lower chamber (211a) to encourage settling of the sediment toward the sediment outlet (219) and cause a central and upward displacement of the water already within the lower chamber (211a).

The lower chamber (211a) comprises a horizontal channel (226) extending from a top portion of the lower chamber (211a), but above the level of the water inlet (212). The channel (226) communicates with an air bleed hose (228) that communicates with a top portion of the upper chamber (211b) above the water level therein in order that air being pushed out of the lower chamber (211a) by incoming water can be displaced to the upper chamber (211b). An air release valve ( ) is disposed near the top of the hose (228).

The upper chamber (211b) comprises a water supply apparatus to re-fill a cleaning machine as shown in and described in relation to FIG. 1. A filter or strainer (not shown) is provided before the fast-fill pump (232) to further improve the cleanliness of the water.

The upper chamber (211b) comprises a water treatment unit (240) and associated pump (241), as shown in and described in relation to FIG. 1. A filter or strainer (not shown) is provided before the treatment unit (240).

The unit (200) comprises an auxiliary water inlet (235) for introducing ‘fresh’ water into the system from time to time as shown in and described in relation to FIG. 1.

The unit (200) is operable via a touch screen controller (not shown) as shown in and described in relation to FIG. 1.

With this arrangement, the unit is easy to assemble, operate and maintain, whilst effectively cleaning water: the minimum number of filters is used and so, maintenance costs and time can be kept to a minimum.

It is to be appreciated, that the units (100, 200) are arranged in practice as a compact columnar mobile module, with the water tanks (111, 211) and other components being supported by a tall, substantially cuboidal frame, which is panelled for safety, practicality and aesthetics.

FIG. 5 is a perspective view of a water recycling unit according to another embodiment. As shown in FIG. 5, the water re-fill unit (10) comprises a water tank (11), a water inlet (12) and a water outlet (13) on said tank for connection to a reservoir of water. The water inlet (12) is adapted to receive water from a reservoir of water. The unit (10) is a stand-alone unit adapted to recycle at least 50% of the water intake from said reservoir of water using at least one water filtration means (14, 15).

The tank (11) is generally rectangular in shape with a base (11a), four side walls (11b) and a top wall (11c). The top wall (11c) of the tank comprises the water inlet (12), whilst the base (11a) comprises a second water outlet (23) which leads to said water outlet (13) for connection to a clean water tank of a cleaning machine. The tank (11) further comprises an auxiliary water inlet (20) for connection to an external water supply. An example volume of the tank (11) is 500 litres.

The unit (10) comprises frame (17), which is either free-standing or can be affixed to a wall or other stable structure, such as a floor. The frame (17) comprises a substantially rectangular frame of tubular metal and comprises four legs (17a), with feet (17b) thereon for stability. Since the frame (17) is load-bearing in that it needs to be able to bear the weight of the water tank (11), the frame (17) is provided with stabilising horizontal bars (17c) between adjacent legs (17a) in a lower region thereof.

The frame (17) further provides a shelf (18) to receive the water tank (11). The shelf (18) is provided in an elevated position relative to a ground surface and provides four horizontal angle (L-shaped) bars (18a), which extend between adjacent legs (17a) in an upper region thereof. The angle-bars (18a) each face inwardly to receive bottom edges of the tank (11). The shelf (18) further provides a plurality of support bars (18b), which extend between opposite horizontal bars (18a) upon which the base (11a) of the tank (11) sits. Upwardly of the shelf (18) and at, or close to a top end of the legs (17a), the frame (17) comprises an upper support structure (19). The support structure (19) comprises four horizontal bars (19a), which extend between adjacent legs (17a). The support structure (19) supports the side walls (11b) of the tank (11), to maximise stability.

The water inlet (12) comprises a connection (12a) to a pipe (21), which is adapted to connect to a water outlet of a cleaning machine (not shown). The pipe (21) is long to allow it to reach to a cleaning machine parked close by and a significant length of the pipe (21) is stored (coiled into) in a housing (22) appended to one side of the frame (17) for convenience. The pipe (21) therefore comprises one or a series of suitable adaptors (21a) for a water tight connection with a cleaning machine. The adaptors (21a) comprise a filter therein. One adaptor (not shown) comprises a U-bend to facilitate immediate settling out of large solids, which minimises the blocking of the filtration means.

A further adaptor (30) for attachment to the pipe (21) of the current adaptor (21a) of the unit (10) is shown in FIG. 4. The adaptor (30) for connection to a water conductor, such as a pipe (21) is suitable for location in a water reservoir, such as a water tank of a cleaning machine, to facilitate water intake therefrom. The adaptor (30) is heavy to facilitate sinking to a bed of the water tank/reservoir and comprises a filtration member (31) through which water intake is effected and a connector (32) for attachment to the water conductor.

The adaptor (30) is removably attachable to the pipe (21) or the adaptor (21a) via the connector (32).

The adaptor further (33) comprises a base which is flat-bottomed (33a) and hollow. The base (33) is approximately 20 mm deep. The base (33) sits on the bed of a water tank or reservoir that is to be emptied of water. The depth of the base minimises the possibility of intake of settled sediment on the base of the water tank or reservoir in addition to minimising the filtration member (31) from being blocked with already settled sediment on the base of the tank/reservoir.

The filtration member (31) comprises a hollow cone-shaped member that extends from an upper face (33b) of the base (33). The hollow of the filtration member (31) and the base (33) are connected. The filtration device comprises longitudinal apertures (31a) for water intake there through. The apertures (31a) extend from near a base (31b) of the cone to near a top (31c) of the cone and they narrow towards the top of the cone (31c). The apertures (31a) are approximately 8 mm wide at the widest part to prevent large particles from being drawn there through.

The connector (32) comprises a hollow open-ended conduit for connection to the pipe (21) or the adaptor (21a). The hollow of the connector (32) communicates with the hollow of the filtration member (31) and extends from the top (31c) of the filtration member (31).

The connector (32), filtration member (31) and the base (33) are integrally formed from metal with a rust-prevention coating, which is preferably, a water ingress-resistant plastics coating.

In use, the pipe (21) or the adaptor (21a) is connected to the connector (32) and the adaptor (30) is then dropped into a water tank reservoir. Due to the weight of the adaptor (30), it sinks to the bottom of the tank/reservoir with the pipe (21) attached. Due to the configuration of the adaptor (30), the flat bottom of the base (33) rests on the bed of the tank/reservoir, with the filtration member (31) standing substantially upright in the tank/reservoir. Once the suction mechanism is employed, the water in the tank/reservoir is drawn through the apertures (31a) into the filtration member (31) and up through the connector (32) into the pipe (21) to the unit 910). The hollow base (33) collects any heavy sediment that passes through the apertures (31a). Once the water level in the tank/reservoir falls below the level of the apertures (31a), water collection ceases. This means that due to the depth of the base (33), the sediment already on the bed of the tank/reservoir is generally not drawn in though the apertures (31a) unless the sediment is agitated.

This adaptor (30) is utilised as a primary/crude filtration means and a means for effectively emptying a tank/reservoir of water.

The adaptor (30) may be used with the unit (10), but may also be used with other apparatus where a water conductor is being used to empty a water reservoir.

The pipe (21) also comprises a water extraction means in the form of a diaphragm pump (21b) for increasing the efficiency with which the water can be sucked out of the cleaning machine and up to the top (11c) of the tank (11). The pump (21b) is powered through connection with the DC battery (not shown) on-board the cleaning machine by connection of an electrical lead with a DC connector to the DC battery.

The auxiliary water inlet (20) provides a means for refreshing the water in the tank (11) during recycling of the extracted machine water. The inlet provides a simple connection to a hose (20a), which can be easily attached to a tap on a sink, or an outside tap, or even a tap on a water butt. The auxiliary inlet (20) is attached to a float valve (22) located inside the tank, such as a Torbeck® float valve by Opella Limited, which delays the opening of the valve so allowing the tank (11) to be filled through the inlet (12) before the tank is topped-up by the required amount and closes the valve once the tank is deemed full.

The water inlet (12) feeds directly into the top of a first filtration means (14). The first filtration means (14) comprises a filter basket (perforated) which extends internally from the top (11c) towards the base (11b) of the tank (11), although in exemplary embodiments, the basket is suspended from the top of the tank (11). The filter basket carries a 250 μm filter therein. Water passing into the first filtration means (14) from the water inlet (12) is filtered of all particles that are of a size of 250 μm or more, by passing out of the filter via a perforated side wall (14a) thereof.

The unit (10) further comprises bio-digester (16), which is connected to the water tank (11) independently. An example is Hydro Engineering's Hydro-Biodigesters (HBD). The bio-digester is operable to automatically dose the tank (11) with bio-digesters on a daily basis. The bio-digesters comprise a variety of bacteria and enzymes that prevent odour, facilitate filtration by digesting unwanted particles and therefore, improving the quality of the water exiting the tank (11) at the second water outlet (23).

The bio-digester may be supplemented with a cleaning aid.

The second water outlet (23) exits the base (11a) of the tank (11) at a location offset from that of the first filtration means (14). The outlet (23) is connected to a second filtration means (15) located outside the tank (11). The second filtration means (15) is a 100 μm filter. Water passing into the second filtration means (14) directly from the water tank (11) is further filtered of all particles that are of a size of 100 μm or more, by passing through the filter on its way to a control valve (24), such as a suitable ball valve, for controlling water flow out of the water outlet (13), once connected to a water inlet of a cleaning machine.

The unit (10) is installed by simply placing it in a convenient location, within hose-distance of a water supply. The unit is most conveniently located on a wall and can be wall mounted for safety and ease. No plumbing or electrical connections are required for installation.

In use, a hose (20a) is connected to a water supply and the valve (24) can be in a ‘closed’ position. A cleaning machine with a reservoir of dirty water is connected to the unit (10) by removing the pipe (21) from the housing (22) and connecting the pipe adaptor (21a) to a water outlet of a waste tank of the cleaning machine, or dropping the adaptor (30) into the waste water tank. The pump (21b) is attached to the DC battery of the cleaning machine and turned on. The pump (21b) operates to suck the dirty water from the cleaning machine store up through the pipe (21) and into the first filter (14) via the inlet (12). The water passes through the first filter (14) and into the tank (11). A small proportion of the water passes out of the tank (11) through the second outlet (23) and the second filter (15) to the valve (24), but no further until the valve is turned to the ‘open’ position. Once the cleaning machine is empty, the pipe (21) can be detached. At this stage, the float valve (22) located at the auxiliary water inlet (20) fills the tank (11) with clean water from another source, up to a required level. The water in the tank (11) should be filtered to at least a 250 μm level. The second stage of filtration occurs as the water passed through the second filter (15) on its way to the exit valve (24) and the outlet (13). Accordingly, the ‘fresh’ water and the recycled water passes through the second stage of filtration. The outlet (13) is attached to a water inlet of the cleaning machine (which may be the same as the water outlet) and the valve is turned to the ‘open’ position. Under the action of gravity, the water from the tank (11) automatically drains through the second outlet (23), through the second filter (15), through the valve (24) and the outlet (13) and into the cleaning machine.

Of course, if a cleaning machine has both a waste water tank and a clean water tank, with their own inlet/outlet, then the filling, filtration and re-fill can occur simultaneously.

The water entering the cleaning machine is in most cases comprised of least 50% recycled water and ‘fresh’ water which has all been filtered to a 50 μm standard. However, in some instances, up to approximately 95% of recycled water makes up the water entering the cleaning machine.

The suction-assisted emptying mechanism and the gravity operated recycling and re-filling system allows a machine to be ready to operate again in a matter of minutes. For example, with a 20 litre/min capacity pump, a 500 litre waste water tank can be emptied in approximately 25 minutes: with filtration and re-fill occurring simultaneously at the rate at which the water is fed into the machine under the gravity feed system, the machine can be ready to operate again in approximately 25 minutes. In a further example, with a 20 litre/min capacity pump, a 250 litre waste water tank can be emptied in approximately 12.5 minutes: with filtration and re-fill occurring simultaneously at the rate at which the water is fed into the machine under the gravity feed system, the machine can be ready to operate again in approximately 12.5 minutes.

The recycling system keeps water costs to a minimum, whilst ensuring that the water is safe and clean enough for use in a cleaning machine. In addition, with a top-up intake of ‘fresh’ water, it ensures that there is gradual ‘refreshing’ of the water being used in a single cleaning machine over the course of a number of cycles. For example, where 95% of water is recycled each time, twenty cycles would completely re-fresh the water, where 90% of water is recycled each time, ten cycles would completely re-fresh the water, and where 50% of water is recycled each time, two cycles would completely re-fresh the water. The efficiency of the recycle yield will depend greatly on whether the cleaning machine has its own on-board water filtration system and how effective it is.

Although a preferred embodiment has been shown and described, it will be appreciated by those skilled in the art that various changes and modifications might be made without departing from the scope of the invention.

1. A water recycling unit for use with a reservoir of water, comprising:
a single water tank;
a water inlet on said tank; and
a water outlet on said tank for connection to said reservoir of water,
the water inlet being adapted to receive water from the reservoir of water into said water tank, and the water outlet being adapted to supply water to said reservoir,
wherein the water outlet is located at a top of said water tank and the water inlet is located below said water outlet, wherein the water tank comprises a settling arrangement and the unit comprises a coagulant delivery apparatus either at or before said water inlet,
said settling arrangement comprising an upper settling chamber and a lower settling chamber,
said upper settling chamber comprising a water supply apparatus,
said water supply apparatus comprising a float disposed in the upper settling chamber, said float being connected to the water outlet via a water conduit adapted to float at the water surface.

2. (canceled)

3. The unit according to claim 1, wherein the lower chamber comprises a primary settling apparatus.

4. The unit according to claim 1, wherein the lower chamber comprises a base with an inverted pyramidal-shape.

5. The unit according to claim 4, wherein the lower chamber comprises a sediment outlet located substantially centrally in the base.

6. The unit according to claim 5, wherein the sediment outlet is connected to a sediment draining or expulsion apparatus with a manually operable cleaning or flushing nozzle.

7. The unit according to claim 1, wherein the water inlet is located proximal to a middle or top portion of the lower chamber.

8. The unit according to claim 7, wherein the water inlet is adapted to introduce incoming water into the lower chamber tangentially to an inner wall thereof, at a substantially horizontal tangent.

9. The unit according to claim 1, wherein the unit comprises a water extraction apparatus adapted to extract water from said reservoir comprising a water conveying apparatus adapted to convey incoming water to said water inlet and said coagulant delivery apparatus is adapted to supply a coagulant dosage to said incoming water within the water conveying apparatus.

10-12. (canceled)

13. The unit according to claim 9, wherein an end of the water conveying apparatus comprises a detachable adaptor for dropping into the water tank of the cleaning machine for intake of water into the water conveying apparatus.

14. (canceled)

15. The unit according to claim 1, wherein the upper chamber of the water tank comprises an inverted cone-shaped base which extends into the lower chamber providing an opening thereto located at, or below the level of the water inlet.

16. The unit according to claim 15, wherein the opening and therefore the cone-shaped base is located substantially centrally in the lower chamber and extends proximal to the base of the lower chamber.

17. (canceled)

18. The unit according to claim 1, wherein the upper chamber comprises a water supply apparatus comprising the water outlet and a water conveying apparatus.

19. (canceled)

20. The unit according to claim 1, wherein the upper chamber comprises a water treatment component.

21. The unit according to claim 20, wherein the water treatment component comprises an electrically converting water part, using electrodes to split the water into anolytes and catholytes with disinfection and cleaning properties respectively.

22-23. (canceled)

24. The unit according to claim 1, wherein the unit is operable by a controller, wherein the controller is a touch screen controller providing one or more of the following options: ‘fast fill’ (operable to quickly fill a reservoir of water with recycled water); ‘recycle’ (operable to extract and clean dirty water from a reservoir); and ‘clean me’ (operable to flush the settled sediment and debris from the unit).

25. (canceled)

26. The unit according to claim 24, wherein the ‘recycle’ option comprises a mandatory unit cleaning procedure before offering the ‘recycle’ procedure.

27. The unit according to claim 1, wherein the unit comprises an auxiliary water inlet provided in the upper chamber of the water tank connected to a ‘fresh’ water source for introducing ‘fresh’ water into the system.

28-29. (canceled)

30. A water re-fill unit for use with cleaning machines, comprising:
a water tank;
a water inlet on said tank; and
a water outlet on said tank for connection to a cleaning machine, wherein the water inlet is adapted to receive water from a cleaning machine and wherein the unit comprises a stand-alone system adapted to recycle at least 50% of the water intake from said cleaning machine using at least one water filtration means.

31. An adaptor for connection to a water conductor, the adaptor being suitable for location in a water reservoir to facilitate water intake therefrom, wherein the adaptor comprises a mass great enough to facilitate sinking to a bed of the water reservoir, a filtration member through which water intake is effected and a connector for attachment to the water conductor.

32-36. (canceled)

37. A water recycling unit according to claim 9 comprising an adaptor for connecting to a water conductor, the adaptor being suitable for location in a water reservoir to facilitate water intake therefrom, wherein the adaptor comprises a mass great enough to facilitate sinking to a bed of the water reservoir, a filtration member through which water intake is effected and a connector for attachment to the water conductor.
